(19) United States
(12) Patent Application Publication
(10) Pub. No.: US 2025/0211474 A1
(43) Pub. Date: Jun. 26, 2025

(54) SOUNDING REFERENCE SIGNALS FOR COHERENT JOINT TRANSMISSION IN A TIME DIVISION DUPLEX SYSTEM

(71) Applicant: MEDIATEK INC., Hsinchu City (TW)

(72) Inventors: Tzu-Han CHOU, San Jose, CA (US); Chia-Hao YU, Hsinchu City (TW); Yahia Ahmed Mahmoud Mahmoud SHABARA, San Jose, CA (US); Parisa CHERAGHI, San Jose, CA (US)

(21) Appl. No.: 18/849,166

(22) PCT Filed: Apr. 13, 2023
(86) PCT No.: PCT/CN2023/088057

§ 371 Date: Sep. 20, 2024

Related U.S. Application Data
(60) Provisional application No. 63/331,909, filed on Apr. 18, 2022.

(51) Int. Cl. H04L 27/26; H04W 72/0446; H04W 72/0453

(52) U.S. Cl. CPC H04L 27/261; H04L 27/2607; H04W 72/0446; H04W 72/0453

(57) ABSTRACT

A method includes receiving, at a user equipment device (UE) from a transmission and reception point (TRP), an uplink CSI measurement configuration including a sounding reference signal (SRS) resource configuration indicating one or more of SRS resource randomization configurations of a cyclic shift, a comb offset, and a time domain orthogonal cover code (TD-OCC); and transmitting SRSs in a sequence of symbols, according to the SRS resource configuration, wherein the SRSs are determined according to the one or more of SRS resource randomization configurations of the cyclic shift, the comb offset, and the TD-OCC, values of the one or more of SRS resource randomization configurations being randomized symbol-by-symbol according to at least one of a cell-specific identity (ID_{cell}) and a UE-specific identity (IDᵤₑ).

### CROSS REFERENCE TO RELATED APPLICATIONS

The present application claims priority to U.S. Provisional Application No. 63/331,909, entitled “SRS enhancement for CJT in TDD system,” filed on Apr. 18, 2022. The U.S. Provisional Application is incorporated herein by reference in its entirety.

### TECHNICAL FIELD

The present disclosure relates generally to wireless communication, and more particularly to sounding reference signals (SRSs) for coherent joint transmission (CJT) in a time division duplex (TDD) system.

### BACKGROUND

Coherent joint transmission (CJT) enables multiple transmission and reception points (multi-TRPs, or mTRPs) to collaborate in serving user equipment devices (UEs). In a time-division duplex (TDD) system, as the number of transmitter antennas involved in joint transmission increases, obtaining accurate Channel State Information at Transmitter (CSIT) becomes crucial for achieving optimal performance. Reciprocal sounding via sounding reference signals (SRSs) is an effective approach for acquiring the CSIT, enabling the mTRPs to determine the channel characteristics and adjust their transmissions accordingly.

Using a large number of orthogonal resources presents a natural solution to increase the system SRS capacity while avoiding interference. However, since the system has a finite number of resources available for the SRS usage, assigning an unlimited number of resources is impractical.

In order to accommodate higher SRS sounding demands for more users and a greater number of antenna ports, it is desirable to increase the system capacity while reducing interference to the lowest possible level, even if the interference cannot be completely eliminated.

### SUMMARY

Aspects of the disclosure provide a method that includes: receiving, at a user equipment device (UE) from a transmission and reception point (TRP), an uplink CSI measurement configuration including a sounding reference signal (SRS) resource configuration indicating one or more of SRS resource randomization configurations of a cyclic shift, a comb offset, and a time domain orthogonal cover code (TD-OCC); and transmitting SRSs in a sequence of symbols, according to the SRS resource configuration, wherein the SRSs are determined according to the one or more of SRS resource randomization configurations of the cyclic shift, the comb offset, and the TD-OCC, values of the one or more of SRS resource randomization configurations being randomized symbol-by-symbol according to at least one of a cell-specific identity (ID_{cell}) and a UE-specific identity (IDᵤₑ).

In an embodiment, the SRS resource configuration indicates the SRSs are determined by the configuration of the cyclic shift, and the values of the cyclic shift for different symbols are determined based on a symbol index and at least one of the cell-specific identity (ID_{cell}) and the UE-specific identity (IDᵤₑ).

Moreover, the values of the cyclic shift for different symbols are determined based on

$${n}_{SRS}^{cs , i} ( l ) = ( {n}_{0} + {n}_{r} ( l ) + \frac{{n}_{SRS}^{cs , max} \cdot {p}_{i}}{{N}_{a p}} ) mod {n}_{SRS}^{cs , max} ,$$

where l is a symbol index, n₀ is an initial cyclic shift offset, nᵣ(l) is an additive term that is determined on a symbol-by-symbol basis, n_{SRS}^{cs,max} is a maximum number of all cyclic shifts, pᵢ is an SRS port index, and Nₐₚ is a total number of SRS ports.

Moreover, the SRS resource configuration further includes enable/disable flags γ_{cell}^{CS},γᵤₑ^{CS}, when the enable/disable flags (γ_{cell}^{cs},γᵤₑ^{cs})=(1,0), nᵣ(l)=n_{c}(l), where n_{c}(l) is a cell-specific random integer, and 0≤n_{c}(l)<n_{SRS}^{cs,max}, when the enable/disable flags (γ_{cell}^{cs},γᵤₑ^{cs})=(0,1), nᵣ(l)=nₑ(l), where nₑ (l) is a UE-specific random integer, and 0≤nₑ(l)<n_{SRS}^{cs,max}, and when the enable/disable flags (γ_{cell}^{cs},γᵤₑ^{cs})=(1,1), nᵣ(l)=n_{c}(l)+nₑ(l), where 0≤n_{c}(l)<n_{SRS}^{cs,max}, and 1≤nₑ(l)<n_{SRS}^{cs,max}.

In an embodiment, the SRS resource configuration indicates the SRSs are determined by the configuration of the comb offset, and the values of the comb offset for different symbols are determined based on a symbol index and one of the cell-specific identity (ID_{cell}) and the UE-specific identity (IDᵤₑ).

Moreover, the values of the comb offset for different symbols are determined based on:

$${\overline{k}}_{0}^{( {p}_{i} )} ( l ) = {n}_{shift} {N}_{sc}^{RB} + ( {k}_{TC}^{( {p}_{i} )} + {k}_{r} ( l ) ) mod {K}_{TC} ,$$

where l is a symbol index, 0≤l<N_{sym}, N_{sym} is a total number of SRS symbols, pᵢ is an SRS port index, k̅₀^{(p}^{ᵢ}⁾(l) is a frequency domain starting position, n_{shift} is a frequency domain shift value, which adjusts SRS allocation with respect to a reference point grid, N_{sc}^{RB} is a number of subcarriers per resource block, k_{TC}^{(p}^{ᵢ}⁾ is the comb offset for port pᵢ, kᵣ(l) is an additive term that is determined on a symbol-by-symbol basis, and K_{TC} is a comb size.

Moreover, the SRS resource configuration further includes enable/disable flags γ_{cell}^{comb},γᵤₑ^{comb}, when the enable/disable flags (γ_{cell}^{comb},γᵤₑ^{comb})=(1,0), kᵣ(l)=u_{cell}(l), where u_{cell}(l) is a l-th element of a cell-specific random permutation of an uniform sequence

$$u = ( 0 , d , 2 d , … , ( {N}_{sym} - 1 ) d ) , d = ⌈ \frac{{K}_{TC}}{{N}_{sym}} ⌉ ,$$

and when the enable/disable flags (γ_{cell}^{comb},γᵤₑ^{comb})=(0,1) or (1,1), kᵣ(l)=uᵤₑ(l), where uᵤₑ(l) is a l-th element of a UE-specific random permutation of the uniform sequence u, and u_{cell}(l)≠uᵤₑ(l)∀l.

Moreover, the values of the comb offset for different symbols are determined to achieve a uniform resource element distribution across a frequency domain.

In an embodiment, the SRS resource configuration indicates the SRSs are determined by the configuration of the TD-OCC, the TD-OCC applied to the SRS sequence being determined based on a TD-OCC index u that depends on the cell-specific identity (ID_{cell}) or the UE-specific identity (IDᵤₑ).

Moreover, the SRS resource configuration further includes enable/disable flags γ_{cell}^{OCC}, γᵤₑ^{OCC}, when the enable/disable flags (γ_{cell}^{occ},γᵤₑ^{occ})=(1,0), u=u_{c}, where u_{c} is a cell-specific index, which depends on the cell-specific identity (ID_{cell}), and when the enable/disable flags (γ_{cell}^{occ}, γᵤₑ^{occ})=(0,1) or (1,1), u=uₑ, where uₑ is a UE-specific index, which depends on the UE-specific identity (IDᵤₑ), and uₑ≠u_{c}.

Aspects of the disclosure provide an apparatus that includes circuitry configured to: receive, at a user equipment device (UE) from a transmission and reception point (TRP), an uplink CSI measurement configuration including a sounding reference signal (SRS) resource configuration indicating one or more of SRS resource randomization configurations of a cyclic shift, a comb offset, and a time domain orthogonal cover code (TD-OCC); and transmit SRSs in a sequence of symbols, according to the SRS resource configuration, wherein the SRSs are determined according to the one or more of SRS resource randomization configurations of the cyclic shift, the comb offset, and the TD-OCC, values of the one or more of SRS resource randomization configurations being randomized symbol-by-symbol according to at least one of a cell-specific identity (ID_{cell}) and a UE-specific identity (IDᵤₑ).

Note that this summary section does not specify every embodiment and/or incrementally novel aspect of the present disclosure or claimed invention. Instead, the summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIGS. 1A and 1B show different scenarios in which cross-SRS interference may become a concern;

FIG. 2 shows a non-limiting example of comb offset randomization configuration;

FIG. 3 shows a uniform marginal resource distribution;

FIG. 4 shows a non-limiting example of TD-OCC with a symbol repetition factor R=4;

FIG. 5 shows an exemplary combination of cyclic shift configuration randomization and comb offset configuration randomization;

FIG. 6 shows a flow chart of an exemplary process 600 in accordance with embodiments of the disclosure; and

FIG. 7 shows an exemplary apparatus 700 in accordance with embodiments of the disclosure.

### DETAILED DESCRIPTION OF EMBODIMENTS

The following disclosure provides different embodiments, or examples, for implementing different features of the provided subject matter. Specific examples of components and arrangements are described below to simplify the present disclosure. These are, of course, merely examples and are not intended to be limiting.

For example, the order of discussion of the different steps as described herein has been presented for the sake of clarity. In general, these steps can be performed in any suitable order. Additionally, although each of the different features, techniques, and configurations, etc., herein may be discussed in different places of this disclosure, it is intended that each of the concepts can be executed independently of each other or in combination with each other. Accordingly, the present disclosure can be embodied and viewed in many different ways.

Furthermore, as used herein, the words “a,” “an,” and the like generally carry a meaning of “one or more,” unless stated otherwise.

The present disclosure provides methods and apparatus for improving the performing of coherent joint transmission (CJT) in time division duplex (TDD) systems using enhanced sounding reference signals (SRSs). The system SRS capacity can be significantly increased by using non-orthogonal resources. By randomizing the configuration of SRS resources on a symbol-by-symbol basis, cross-SRS interference on transmission and reception points (TRPs) can be reduced.

### I. Cross-SRS Interference

In CJT, in order to obtain relative phase at TRPs, one or multiple SRSs within coherence time are sent by a UE and received by multiple TRPs. Here, the channel of the coherence time can be the entire path including the propagation channel and the transmission/reception (Tx/Rx) processing chains. When SRS resource reuse occurs or non-orthogonal SRS resources are used by multiple UEs, it can cause cross-SRS interference on TRPs, which is commonly known as “pilot contamination.”

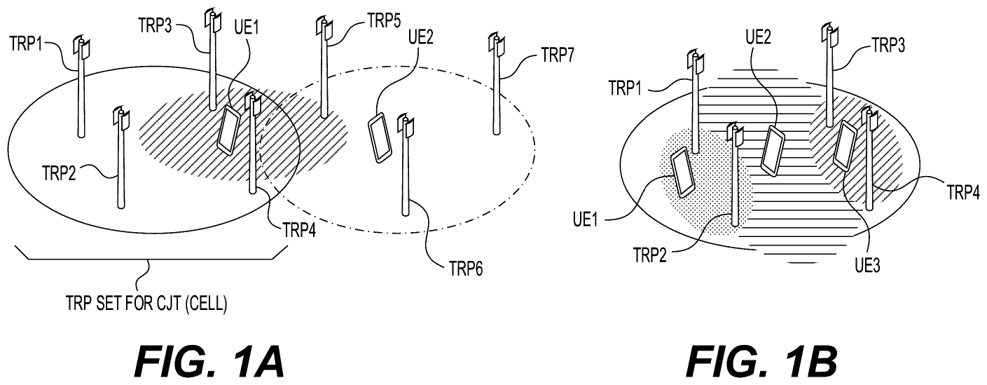

Two scenarios of cross-SRS interference are exemplified in FIGS. 1A and 1B. In particular, FIG. 1A depicts inter-cell interference, where signals from adjacent cells interfere with each other. On the other hand, FIG. 1B illustrates intra-cell interference, which occurs when SRS signals from different UEs within the same cell interfere with each other.

In FIG. 1A, a TRP set for CJT, including TRP1, TRP2, TRP3, and TRP4, is depicted by the left oval. Meanwhile, the right oval represents another TRP set consisting of TRP5, TRP6, and TRP7. The TRPs 1-4 belong to a first cell. The TRPs 1-4 within the left TRP set collaborate, utilizing orthogonal resources, to prevent interference within their set. Similarly, the TRPs 5-7 within the right TRP set cooperate and also use orthogonal resources, effectively mitigating interference within their respective set. The TRPs 5-7 belong to a second cell.

However, interference can occur at the overlapping region, also known as the cell edge, between the two different TRP sets. For example, in the downlink direction, UE1 may receive signals from the TRPs within the left TRP set, while in the uplink, the SRS signal transmitted by UE1 to TRPs 1-4 may be received by TRPs 5-7. When adjacent TPR sets use orthogonal SRS resources, even if there are signal leaks, they will not cause interference. However, when the two TRP sets are not scheduled jointly, such as if the SRS signal transmitted by UE1 to TRPs 1-4 occupies the same resources used by the right TRP set's SRS transmissions, then TRPs 5-7 may experience interference from UE1 while receiving SRS signals.

In FIG. 1B, there are three TRPs (TRPs 1-3) that serve several user equipment devices (UEs 1-3) located within the same cell. The transmission power of the SRS signals from the UEs is restricted by the UEs' power limit. Hence, the interference generated by these signals is typically limited to a certain range within the cell but not the whole cell area. In this case, it is possible for the UEs to use non-orthogonal resources. For example, resource reuse between UE1 and UE3 may not lead to interference since they are farther apart. However, utilizing non-orthogonal SRS resources between two neighboring UEs, such as UE2 and UE3, or UE1 and UE2, could cause residual interference.

### II. SRS Resource Configurations

A variety of mechanisms are available to allocate specific resource elements to different UEs for their SRS transmissions, including (1) cyclic shifts (CS), (2) comb offsets, and (3) a time domain orthogonal cover code (TD-OCC), for example.

### (1) Cyclic Shifts

The rationale of cyclic shifts is that a phase rotation in the frequency domain is equivalent to a cyclic shift in the time domain. By applying different phase rotations, it is possible to generate multiple orthogonal SRSs that can be transmitted simultaneously in the same resource element. Therefore, by assigning different phase rotations to different UEs, multiple SRS from these UEs can be transmitted in parallel.

### (2) Comb Offsets

To enable simultaneous transmission of SRSs from multiple UEs, a comb structure can be employed in the frequency domain for SRS transmission. That is, SRS can be transmitted from a UE on every N-th subcarrier, where N can take the values 2, 4, 8, etc. Therefore, SRS transmissions from different UEs are frequency multiplexed by assigning them to different frequency shifts, or “comb offsets.”

### (3) TD-OCC

In addition to cyclic shifts and comb offsets, TD-OCC can be used to enhance the SRS capacity in the code domain. This approach includes using a codebook containing a set of sequences that have been specifically designed to be orthogonal to one another. By using this codebook, additional orthogonal sequences can be generated, thereby ensuring the orthogonality of the SRS signals.

Typically, the parameters of the cyclic shifts, comb offsets and TD-OCC are configured by higher layer signaling. Once a specific configuration is established, the SRS resource mapping in the time domain, frequency domain, and code domain is fixed. Therefore, after a collision happens for the first time, the SRS interference will happen continuously. For instance, if two 4-symbol SRS signals collide on the first symbol, they will continue to collide on the subsequent symbols, rendering the SRSs unusable for the TRPs.

To mitigate the above issue, SRS interference randomization can be introduced. This can be achieved by applying different configurations of cyclic shifts, comb offsets, and/or TD-OCC over time to avoid continuous SRS interference for TRPs.

### III. SRS Interference Randomization

The embodiments described below with reference to the accompanying drawing demonstrate methods and apparatus for reducing the impact of cross-SRS interference by incorporating randomization into one or more of the three types of SRS resource configurations mentioned above.

According to embodiments of the disclosure, randomization or hopping can be performed on a symbol-to-symbol basis to randomize the interference across different SRSs transmitted by multiple UEs. For example, a network-configured ID, such as a cell-specific identity (ID_{cell}) and/or a UE-specific identity (IDᵤₑ), can be used in randomizing certain values of the cyclic shifts, comb offsets, and/or TD-OCC configurations. In addition, a pair of enable/disable flags γ_{cell}^{cs},γᵤₑ^{cs}∈{0,1} can be used to individually indicate which one of or both the cell-specific randomization and the UE-specific randomization are valid.

However, there is a potential concern when using both the cell-specific randomization and the UE-specific randomization simultaneously. For example, Cell 1 and Cell 2 are orthogonal based on a randomization mechanism at the cell level, but with additional time-domain, frequency-domain, and/or code-domain randomization at the UE level, collisions may occur on some resources. Such collisions can be avoided by proper design of the values of the cyclic shifts, comb offsets, and/or TD-OCC configurations, as illustrated in the following embodiments.

### Embodiment 1: Random Cyclic Shift Hopping

An SRS sequence for an SRS port pᵢ (0≤pᵢ<Nₐₚ) can be generated by a cyclic shift αᵢ of a base sequence r̅_{u,v}(n) according to:

$${r}_{u , v}^{( {α}_{i} , δ )} ( n ) = {e}^{j {α}_{i} n} {\overline{r}}_{u , v} ( n )$$

where Nₐₚ is the total number of SRS ports,

$${α}_{i} = 2 π \frac{{n}_{SRS}^{cs , i}}{{n}_{SRS}^{cs , max}} ,$$

δ=log₂ K_{TC}, n is a sequence index, u is a base sequence group index, v is a base sequence index within the group, n_{SRS}^{cs,max} is the maximum number of the CS shifts, and K_{TC} is the transmission comb number. The length of the SRS sequence can vary based on different configurations, such as the bandwidth size and comb number, etc.

Let l denote a symbol index in the SRS sequence, where l=0 corresponds to the first symbol in the sequence. The term n_{SRS}^{cs,i}(l) can specify the delay of the space-time reference signal streams. Allocating a separate delay to each port stream with enough margin can result in orthogonality between the streams. As long as the term n_{SRS}^{cs,i}(l) takes different values for different symbols, the cyclic shift at will have different values for different symbols. This can be done by introducing into the calculation of n_{SRS}^{cs,i}(l) an additional additive term nᵣ(l) which can be a function of the symbol index and a cell-specific identity (ID_{cell}) and/or a UE-specific identity (IDᵤₑ):

$${n}_{SRS}^{cs , i} ( l ) = ( {n}_{0} + {n}_{r} ( l ) + \frac{{n}_{SRS}^{cs , max} \cdot {p}_{i}}{{N}_{ap}} ) mod {n}_{SRS}^{cs , max}$$

where n₀ is the initial CS offset. As mentioned above, the enable/disable fags γ_{cell}^{cs} and γᵤₑ^{cs} provide the ability to selectively turn ON/OFF the cell-specific and UE-specific randomization. If the enable/disable flags (γ_{cell}^{cs},γᵤₑ^{cs})=(1,0), only the cell-specific randomization is used. In this case, a cell-specific random integer shift n_{c}(l) is set as the term nᵣ(l), i.e., nᵣ(l)=n_{c}(l), where 0≤n_{c}(l)<n_{SRS}^{cs,max}.

On the other hand, if the enable/disable flags (γ_{cell}^{cs}, γᵤₑ^{cs})=(0,1), only the UE-specific randomization is valid. In this case, a UE-specific random integer shift nₑ(l) is set as the term nᵣ(l), i.e., nᵣ(l)=nₑ(l), where 0≤nₑ(l)<n_{SRS}^{cs,max}.

When both flags are set to 1, indicating the simultaneous use of the cell-specific randomization and the UE-specific randomization, nᵣ(l) is calculated as a sum of the cell-specific random integer shift n_{c}(l) and the UE-specific random integer shift nₑ(l), i.e., nᵣ(l)=n_{c}(l)+nₑ(l), where 0≤n_{c}(l)<n_{SRS}^{cs,max}, and 1≤nₑ(l)<n_{SRS}^{cs,max}. Since a non-zero nₑ(l) is added on top of n_{c}(l), it is possible to avoid collisions between the two randomization mechanisms.

### Embodiment 2: Random Comb Offset Hopping

The frequency domain starting position for an antenna port pᵢ (0≤pᵢ<Nₐₚ) can be given by:

$${k}_{0}^{( {p}_{i} )} ( l ) = {\overline{k}}_{0}^{( {p}_{i} )} + {\sum }_{b = 0}^{{B}_{SRS}} {K}_{TC} {M}_{sc , b}^{SRS} {n}_{b} ( l )$$

where the comb offset is specified in the first term k̅₀^{(p}^{ᵢ}⁾, l (0≤N_{sym}) is the symbol index in the SRS sequence, K_{TC} is the comb size, and M_{sc,b}^{SRS} is the SRS sequence length (which describes how many subcarriers are occupied in one OFDM symbol by SRS). The parameters k̅₀^{(p}^{ᵢ}⁾, n_{b}(l), b, and B_{SRS} specify where SRS shows up in frequency (subcarrier) and time (symbol).

Normally, the comb offsets are allowed to vary over time, but the way in which they changes is predetermined and not randomized. It is also not specific to the UE or the cell, but is obtained through a lookup table. In contrast, according to this disclosure, randomization is implemented on the comb offsets symbol by symbol, which is achieved in a UE-specific and/or cell-specific manner.

To accomplish random comb offset hopping, an additional additive offset kᵣ(l) can be introduced into the term k̅₀^{(p}^{ᵢ}⁾ as a function of the symbol index and the ID_{cell} and/or IDᵤₑ. In addition, the enable/disable flags γ_{cell}^{comb},γᵤₑ^{comb}∈{0,1} can be used to individually indicate which one of or both the cell-specific randomization and the UE-specific randomization are valid.

For example, the term k̅₀^{(p}^{ᵢ}⁾ for a given symbol I can be calculated according to:

$${\overline{k}}_{0}^{( {p}_{i} )} ( l ) = {n}_{shift} {N}_{sc}^{RB} + ( {k}_{TC}^{( {p}_{i} )} + {k}_{r} ( l ) ) mod {K}_{TC}$$

where the frequency domain shift value n_{shift} adjusts the SRS allocation with respect to the reference point grid, NR_{sc}^{RB} denotes the number of subcarriers per resource block, and k_{TC}^{(p}^{ᵢ}⁾ denotes the comb offset for port pᵢ.

The comb offset hopping can be based on random permutation of a uniform sequence u=(0, d, 2d, . . . , (N_{sym}−1)d), where

$$d = ⌈ \frac{{K}_{TC}}{{N}_{sym}} ⌉ .$$

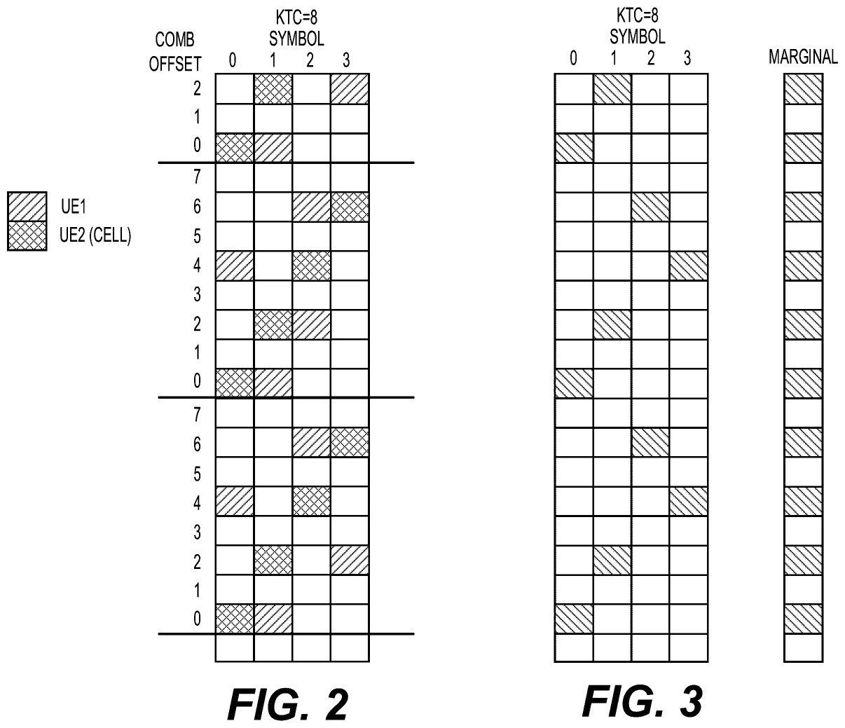

Let u_{cell} and uᵤₑ be two random permutations of u such that u_{cell}(l)≠uᵤₑ(l)∀l. If the enable/disable flags (γ_{cell}^{comb},γᵤₑ^{comb})=(1,0), only the cell-specific randomization is used. In this case, kᵣ(l)=u_{cell}(l). If the enable/disable flags (γ_{cell}^{comb},γᵤₑ^{comb})=(0,1) or (1,1), kᵣ(l)=uᵤₑ(l). FIG. 2 shows a non-limiting example where u_{cell}=(0,2,4,6), uᵤₑ=(4,0,6,2), and K_{TC}=8.

Moreover, it is desirable to distribute the resource elements evenly across the frequency domain, instead of focusing them in either the upper or lower half. This uniform marginal RE density can help to estimate the overall channel conditions in the frequency domain by ensuring a more balanced allocation of resources. An example of a uniform marginal resource distribution is shown in FIG. 3.

### Embodiment 3: Random TD-OCC

In this embodiment, TD-OCC is applied to the SRS sequence in which the same frequency is repeated sounded. TD-OCC is equivalent to as a mask (denoted by W_{occ}^{u}(l)) that is multiplied onto the SRS sequence in order to accomplish the randomization in the code domain. The resulting sequence for symbol I can be given by:

$${r}^{( {p}_{i} )} ( n , l ) = {r}_{u , v}^{( {a}_{i} , δ )} ( n ) \cdot {W}_{occ}^{u} ( l )$$

where u is the OCC code index.

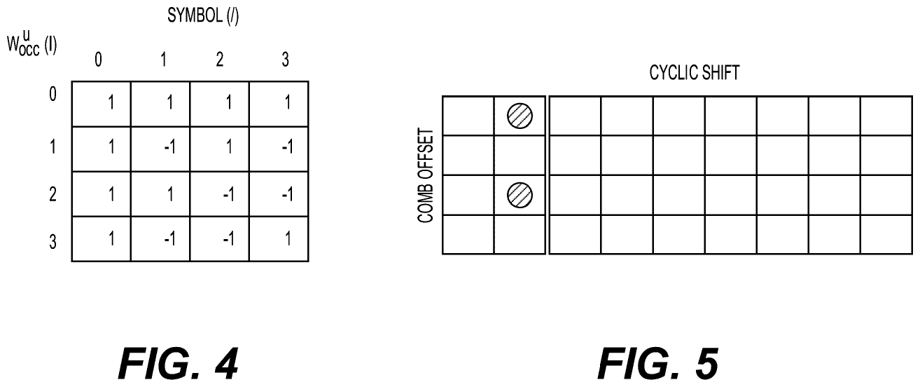

FIG. 4 illustrates an example of a TD-OCC lookup table with a symbol repetition factor R=4. In FIG. 4, four sequences (1, 1, 1, 1), (1, −1, 1, −1), (1, 1, −1, −1), and (1, −1, −1, 1) each have an inner product of zero with one another, making them mutually orthogonal. The enable/disable flags γ_{cell}^{OCC},γᵤₑ^{OCC}∈{0,1} can be used to individually indicate which one of or both the cell-specific randomization and the UE-specific randomization are valid. Given an index value u randomly selected based on the ID_{cell} or the IDᵤₑ, a corresponding mask W_{occ}^{u}(l) is multiplied onto the SRS sequence. When there are enough candidate masks available, the probability of selecting the same mask for different UEs is low.

When the enable/disable flags (γ_{cell}^{occ},γᵤₑ^{occ})=(1,0), only the cell-specific randomization is used. In this case, u=u_{c}, which is the random code index as a function of the ID_{cell}. When the enable/disable flags (γ_{cell}^{occ},γᵤₑ^{occ})=(0,1) or (1,1), u=uₑ, which is random code index as a function of the IDᵤₑ, and uₑ≠u_{c}.

The previous description provides several SRS randomization schemes, including cyclic shifts, comb offsets, and TD-OCC. These schemes enable the maintenance of orthogonality between cell-specific and UE-specific SRS resources, while UE-specific to UE-specific SRS resources can be generally non-orthogonal but randomized. Therefore, even if non-orthogonal resource elements or resource reuse are employed for the purposes of increasing the system SRS capacity, it is possible to avoid continuous SRS interference.

As previously mentioned, two or more configuration randomizations can be combined to use. By utilizing multiple configurations, resource elements are considered orthogonal as long as they are orthogonal in at least one of the configuration dimensions, which allows for more effective averaging out of interference.

FIG. 5 illustrates an exemplary combination of cyclic shifts configuration randomization and comb offsets configuration randomization. The rows in the diagram represent resources partitions using different cyclic shifts, while the columns represent resources partitions using comb offsets. Each resource element, such as the labelled two, can be assigned to a specific UE. Even though these two resource elements have the same cyclic shift across different symbols, they still remain orthogonal because different comb offsets are used.

### IV. Exemplary Process for SRS Transmission

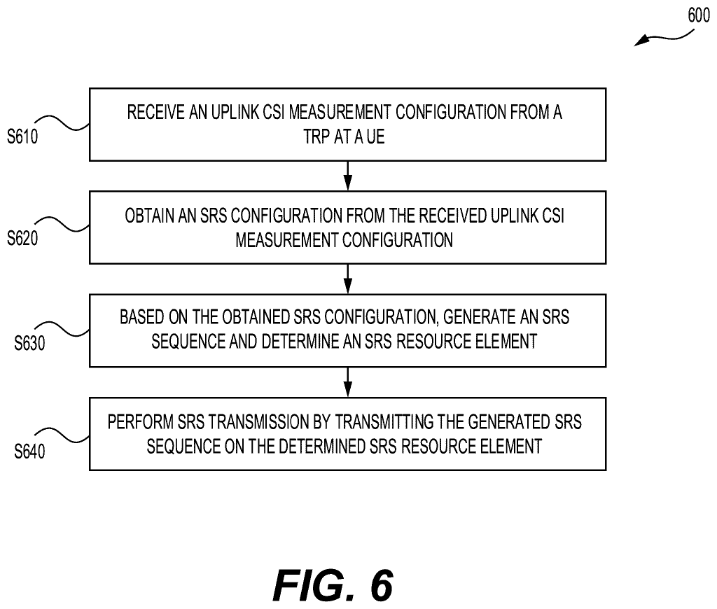

FIG. 6 shows a non-limiting SRS transmission process 600 according to embodiments of the disclosure. The process 600 can be based on SRS randomization in cyclic shifts, comb offsets, and/or TD-OCC.

At step S610, an uplink CSI measurement configuration can be received from a base station at a UE. The base station can be a TRP serving the UE.

At step S620, an SRS configuration can be obtained from the received uplink CSI measurement configuration. The obtained SRS configuration can indicate one or more of SRS resource randomization configurations of a cyclic shift, a comb offset, and a time domain orthogonal cover code (TD-OCC). The SRS configuration can further indicate which one of or both the cell-specific randomization and the UE-specific randomization are valid.

At step S630, an SRS sequence can be generated based on the SRS configuration. An SRS resource element can also be determined based on the SRS configuration.

At step S640, the generated sequence can be transmitted by the UE on the determined SRS resource element. This process 600 is applicable to periodic, semi-persistent, and aperiodic SRS transmission.

### V. Exemplary Apparatus

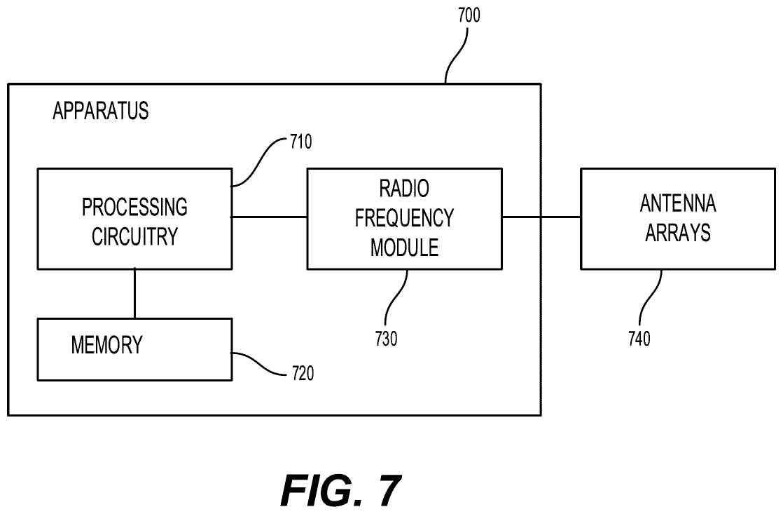

FIG. 7 shows an exemplary apparatus 700 according to embodiments of the disclosure. The apparatus 700 can be configured to perform various functions in accordance with one or more embodiments or examples described herein. Thus, the apparatus 700 can provide means for implementation of mechanisms, techniques, processes, functions, components, systems described herein. For example, the apparatus 700 can be used to implement functions of UEs (or TRPs) in various embodiments and examples described herein. The apparatus 700 can include a general purpose processor or specially designed circuits to implement various functions, components, or processes described herein in various embodiments. The apparatus 700 can include processing circuitry 710, a memory 720, and a radio frequency (RF) module 730.

In various examples, the processing circuitry 710 can include circuitry configured to perform the functions and processes described herein in combination with software or without software. In various examples, the processing circuitry 710 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 710 can be a central processing unit (CPU) configured to execute program instructions to perform various functions and processes described herein. Accordingly, the memory 720 can be configured to store program instructions. The processing circuitry 710, when executing the program instructions, can perform the functions and processes. The memory 720 can further store other programs or data, such as operating systems, application programs, and the like. The memory 720 can include non-transitory storage media, such as a read only memory (ROM), a random access memory (RAM), a flash memory, a solid state memory, a hard disk drive, an optical disk drive, and the like.

In an embodiment, the RF module 730 receives a processed data signal from the processing circuitry 710 and converts the data signal to beamforming wireless signals that are transmitted via antenna arrays 740, or vice versa. In some examples, the RF module 730 can include a digital to analog converter (DAC), an analog to digital converter (ADC), a frequency up converter, a frequency down converter, filters and amplifiers for reception and transmission operations. In some examples, the RF module 730 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 740 can include one or more antenna arrays organized in multiple antenna panels or antenna groups.

The apparatus 700 can optionally include other components, such as input and output devices, additional or signal processing circuitry, and the like. Accordingly, the apparatus 700 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer-readable medium, including magnetic storage medium, optical storage medium, flash medium, and solid-state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving, at a user equipment device (UE) from a transmission and reception point (TRP), an uplink CSI measurement configuration including a sounding reference signal (SRS) resource configuration indicating one or more of SRS resource randomization configurations of a cyclic shift, a comb offset, and a time domain orthogonal cover code (TD-OCC); and
transmitting SRSs in a sequence of symbols, according to the SRS resource configuration, wherein the SRSs are determined according to the one or more of SRS resource randomization configurations of the cyclic shift, the comb offset, and the TD-OCC, values of the one or more of SRS resource randomization configurations being randomized symbol-by-symbol according to at least one of a cell-specific identity (ID_{cell}) and a UE-specific identity (IDᵤₑ).

2. The method of claim 1, wherein the SRS resource configuration indicates the SRSs are determined by the configuration of the cyclic shift, and the values of the cyclic shift for different symbols are determined based on a symbol index and at least one of the cell-specific identity (ID_{cell}) and the UE-specific identity (IDᵤₑ).

3. The method of claim 2, wherein the values of the cyclic shift for different symbols are determined based on
$${n}_{SRS}^{cs , i} ( l ) = ( {n}_{0} + {n}_{r} ( l ) + \frac{{n}_{SRS}^{cs , max} \cdot {p}_{i}}{{N}_{ap}} ) mod {n}_{SRS}^{cs , max} ,$$
where l is a symbol index, n₀ is an initial cyclic shift offset, nᵣ(l) is an additive term that is determined on a symbol-by-symbol basis, n_{SRS}^{cs,max} is a maximum number of all cyclic shifts, pᵢ is an SRS port index, and Nₐₚ is a total number of SRS ports.

4. The method of claim 3, wherein the SRS resource configuration further includes, enable/disable flags γ_{cell}^{CS}, γᵤₑ^{CS},
when the enable/disable flags (γ_{cell}^{cs},γᵤₑ^{cs})=(1,0), nᵣ(l)=n_{c}(l), where n_{c}(l) is a cell-specific random integer, and 0≤n_{c}(l)<n_{SRS}^{cs,max}, and
when the enable/disable flags (γ_{cell}^{cs}, γᵤₑ^{cs})=(0,1), nᵣ(l)=nₑ(l), where nₑ(l) is a UE-specific random integer, and 0≤nₑ(l)<n_{SRS}^{cs,max}, and
when the enable/disable flags (γ_{cell}^{cs}, γᵤₑ^{cs,max})=(1,1), nᵣ(l)=n_{c}(l)+nₑ(l), where 0≤n_{c}(l)<n_{SRS}^{cs,max}, and 1≤nₑ(l)<n_{SRS}^{cs,max}.

5. The method of claim 1, wherein the SRS resource configuration indicates the SRSs are determined by the configuration of the comb offset, and the values of the comb offset for different symbols are determined based on a symbol index and one of the cell-specific identity (ID_{cell}) and the UE-specific identity (IDᵤₑ).

6. The method of claim 5, wherein the values of the comb offset for different symbols are determined based on:
$${\overline{k}}_{0}^{( {p}_{i} )} ( l ) = {n}_{shift} {N}_{sc}^{RB} + ( {k}_{TC}^{( {p}_{i} )} + {k}_{r} ( l ) ) mod {K}_{TC} ,$$
where l is a symbol index, 0≤l<N_{sym}, N_{sym} is a total number of SRS symbols, pᵢ is an SRS port index, k̅₀^{(p}^{ᵢ}⁾(l) is a frequency domain starting position, n_{shift} is a frequency domain shift value, which adjusts SRS allocation with respect to a reference point grid, N_{sc}^{RB} is a number of subcarriers per resource block, k_{TC}^{(p}^{ᵢ}⁾ is the comb offset for port pᵢ, kᵣ(l) is an additive term that is determined on a symbol-by-symbol basis, and K_{TC} is a comb size.

7. The method of claim 6, wherein the SRS resource configuration further includes enable/disable flags γ_{cell}^{comb}, γᵤₑ^{comb},
when the enable/disable flags (γ_{cell}^{comb},γᵤₑ^{comb})=(1,0), kᵣ(l)=u_{cell}(l), where u_{cell}(l) is a l-th element of a cell-specific random permutation of an uniform sequence
$$u = ( 0 , d , 2 d , … , ( {N}_{sym} - 1 ) d ) , d = ⌈ \frac{{K}_{TC}}{{N}_{sym}} ⌉ ,$$
and
when the enable/disable flags (γ_{cell}^{comb}, γᵤₑ^{comb})=(0,1) or (1,1), kᵣ(l)=uᵤₑ(l), where uᵤₑ(l) is a l-th element of a UE-specific random permutation of the uniform sequence u, and u_{cell}(l)≠uᵤₑ(l)∀l.

8. The method of claim 5, wherein the values of the comb offset for different symbols are determined to achieve a uniform resource element distribution across a frequency domain.

9. The method of claim 1, wherein the SRS resource configuration indicates the SRSs are determined by the configuration of the TD-OCC, the TD-OCC applied to the SRS sequence being determined based on a TD-OCC index u that depends on the cell-specific identity (ID_{cell}) or the UE-specific identity (IDᵤₑ).

10. The method of claim 9, wherein the SRS resource configuration further includes enable/disable flags γ_{cell}^{OCC}, γᵤₑ^{OCC},
when the enable/disable flags (γ_{cell}^{occ}, γᵤₑ^{occ})=(1,0), u=u_{c}, where u_{c} is a cell-specific index, which depends on the cell-specific identity (ID_{cell}), and
when the enable/disable flags (γ_{cell}^{occ}, γᵤₑ^{occ})=(0,1) or (1,1), u=uₑ, where uₑ is a UE-specific index, which depends on the UE-specific identity (IDᵤₑ), and uₑ≠u_{c}.

11. An apparatus comprising circuitry configured to:
receive, at a user equipment device (UE) from a transmission and reception point (TRP), an uplink CSI measurement configuration including a sounding reference signal (SRS) resource configuration indicating one or more of SRS resource randomization configurations of a cyclic shift, a comb offset, and a time domain orthogonal cover code (TD-OCC); and
transmit SRSs in a sequence of symbols, according to the SRS resource configuration, wherein the SRSs are determined according to the one or more of SRS resource randomization configurations of the cyclic shift, the comb offset, and the TD-OCC, values of the one or more of SRS resource randomization configurations being randomized symbol-by-symbol according to at least one of a cell-specific identity (ID_{cell}) and a UE-specific identity (IDᵤₑ).

12. The apparatus of claim 11, wherein the SRS resource configuration indicates the SRSs are determined by the configuration of the cyclic shift, and the values of the cyclic shift for different symbols are determined based on a symbol index and at least one of the cell-specific identity (ID_{cell}) and the UE-specific identity (IDᵤₑ).

13. The apparatus of claim 12, wherein the values of the cyclic shift for different symbols are determined based on
$${n}_{SRS}^{cs , i} ( l ) = ( {n}_{0} + {n}_{r} ( l ) + \frac{{n}_{SRS}^{cs , max} \cdot {p}_{i}}{{N}_{ap}} ) mod {n}_{SRS}^{cs , max} ,$$
where l is a symbol index, n₀ is an initial cyclic shift offset, nᵣ(l) is an additive term that is determined on a symbol-by-symbol basis, n_{SRS}^{cs,max} is a maximum number of all cyclic shifts, pᵢ is an SRS port index, and Nₐₚ is a total number of SRS ports.

14. The apparatus of claim 13, wherein the SRS resource configuration further includes enable/disable flags γ_{cell}^{CS},γᵤₑ^{CS},
when the enable/disable flags (γ_{cell}^{cs},γᵤₑ^{cs})=(1,0), nᵣ(I)=n_{c}(l), where n_{c}(l) is a cell-specific random integer, and 0≤n_{c}(l)<n_{SRS}^{cs,max},
when the enable/disable flags (γ_{cell}^{cs}, γᵤₑ^{cs})=(0,1), nᵣ(l)=n_{c}(l), where nₑ (l) is a UE-specific random integer, and 0≤nₑ(l)<n_{SRS}^{cs,max}, and
when the enable/disable flags (γ_{cell}^{cs}, γᵤₑ^{cs})=(1,1), nᵣ(l)=n_{c}(l)+nₑ(l), where 0≤n_{c}(l)<n_{SRS}^{cs,max}, and 1≤nₑ(l)<n_{SRS}^{cs,max}.

15. The apparatus of claim 11, wherein the SRS resource configuration indicates the SRSs are determined by the configuration of the comb offset, and the values of the comb offset for different symbols are determined based on a symbol index and one of the cell-specific identity (ID_{cell}) and the UE-specific identity (IDᵤₑ).

16. The apparatus of claim 15, wherein the values of the comb offset for different symbols are determined based on:
$${\overline{k}}_{0}^{( {p}_{i} )} ( l ) = {n}_{shift} {N}_{sc}^{RB} + ( {k}_{TC}^{( {p}_{i} )} + {k}_{r} ( l ) ) mod {K}_{TC}$$
where l is a symbol index, 0≤l<N_{sym}, N_{sym} is a total number of symbols, pᵢ is an SRS port index, k̅₀^{(p}^{ᵢ}⁾(l) is a frequency domain starting position, n_{shift} is a frequency domain shift value, which adjusts SRS allocation with respect to a reference point grid, N_{sc}^{RB} is a number of subcarriers per resource block, k_{TC}^{(p}^{ᵢ}⁾ is the comb offset for port pᵢ, kᵣ(l) is an additive term that is determined on a symbol-by-symbol basis, and K_{TC} is a comb size.

17. The apparatus of claim 16, wherein the SRS resource configuration further includes enable/disable flags γ_{cell}^{comb}, γᵤₑ^{comb},
when the enable/disable flags (γ_{cell}^{comb},γᵤₑ^{comb})=(1,0), kᵣ(l)=u_{cell}(l), where u_{cell}(l) is a l-th element of a cell-specific random permutation of an uniform sequence
$$u = ( 0 , d , 2 d , … , ( {N}_{sym} - 1 ) d ) , d = ⌈ \frac{{K}_{TC}}{{N}_{sym}} ⌉ ,$$
and
when the enable/disable flags (γ_{cell}^{comb},γᵤₑ^{comb}=(0,1) or (1,1), kᵣ(l)=uᵤₑ(l), where uᵤₑ(l) is a l-th element of a UE-specific random permutation of the uniform sequence u, and u_{cell}(l)≠uᵤₑ(l)∀l.

18. The apparatus of claim 15, wherein the values of the comb offset for different symbols are determined to achieve a uniform resource element distribution across a frequency domain.

19. The apparatus of claim 11, wherein the SRS resource configuration indicates the SRSs are determined by the configuration of the TD-OCC, the TD-OCC applied to the SRS sequence being determined based on a TD-OCC index u that depends on the cell-specific identity (ID_{cell}) or the UE-specific identity (IDᵤₑ).

20. The method of claim 19, wherein the SRS resource configuration further includes enable/disable flags γ_{cell}^{OCC}, γᵤₑ^{OCC},
when the enable/disable flags (γ_{cell}^{occ}, γᵤₑ^{occ})=(1,0), u=u_{c}, where u_{c} is a cell-specific index, which depends on the cell-specific identity (ID_{cell}), and
when the enable/disable flags (γ_{cell}^{occ}, γᵤₑ^{occ})=(0,1) or (1,1), u=uₑ, where uₑ, is a UE-specific index, which depends on the UE-specific identity (IDᵤₑ), and uₑ≠u_{c}.
